(19) United States
(12) Patent Application Publication
(10) Pub. No.: US 2019/0344790 A1
(43) Pub. Date: Nov. 14, 2019

(54) TRAVEL SUPPORT DEVICE

(71) Applicant: DENSO CORPORATION, Kariya-city (JP)

(72) Inventor: Nozomi KITAGAWA, Kariya-city (JP)

(21) Appl. No.: 16/525,028

(22) Filed: Jul. 29, 2019

Related U.S. Application Data
(63) Continuation of application No. PCT/JP2018/009843, filed on Mar. 14, 2018.

(30) Foreign Application Priority Data
Apr. 3, 2017 (JP) 2017-073885

(51) Int. Cl. B60W 30/182; B60W 50/14; G05D 1/00

(52) U.S. Cl. CPC B60W 30/182; B60W 50/14; B60Y 2302/05; B60W 2050/146; G05D 2201/0213; G05D 1/0061

(57) ABSTRACT

A travel support device for a vehicle performing an automatic driving operation includes: a driving mode change unit that performs a driving mode change between the automatic driving operation and a manual driving operation; a vehicle stop unit that stops the vehicle; and a function selection unit that selects one of an on-request mode change function and an automatic stop function, the on-request mode change function being for requesting a driver of the vehicle to perform the driving mode change and performing the driving mode change, and the automatic stop function being for immediately starting to stop the vehicle.

### CROSS REFERENCE TO RELATED APPLICATION

The present application is a continuation application of International Patent Application No. PCT/JP2018/009843 filed on Mar. 14, 2018, which designated the U.S. and claims the benefit of priority from Japanese Patent Application No. 2017-073885 filed on Apr. 3, 2017. The entire disclosures of all of the above applications are incorporated herein by reference.

### TECHNICAL FIELD

The present disclosure relates to a travel support device supporting travel of a vehicle.

### BACKGROUND

There is a technique of preliminarily determining whether continuation of automatic driving becomes impossible in a position forward of a present vehicle on the basis of predicted road conditions, preannouncing automatic driving cancellation and, after that, when the distance to a point where automatic driving cannot be continued becomes equal to or less than a predetermined value, cancelling the automatic driving and switching to manual driving.

### SUMMARY

According to an example embodiment, a travel support device for a vehicle performing an automatic driving operation includes: a driving mode change unit that performs a driving mode change between the automatic driving operation and a manual driving operation; a vehicle stop unit that stops the vehicle; and a function selection unit that selects one of an on-request mode change function and an automatic stop function, the on-request mode change function being for requesting a driver of the vehicle to perform the driving mode change and performing the driving mode change, and the automatic stop function being for immediately starting to stop the vehicle.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a diagram illustrating an example of a schematic configuration of a travel support system;

FIG. 2 is a diagram illustrating an example of a schematic configuration of an automatic driving ECU;

FIG. 3 is a flowchart illustrating an example of the flow of driving change related process of the automatic driving ECU;

FIG. 4 is a diagram for explaining the difference between following vehicle control in the case where an on-request change function is selected by a function selection unit and that in the case where an immediate stop function is selected; and

FIG. 5 is a diagram illustrating an example of a schematic configuration of an automatic driving ECU.

### DETAILED DESCRIPTION

A vehicle performing automatic driving is requested to have a function of continuing automatic driving only for a predetermined period after a request of driving change to a driver so that the driver can start manual driving while continuing travel of the vehicle at the time of driving change from automatic driving to manual driving.

However, there may be not only the planned driving change but also an unplanned driving change due to a trouble, precision deterioration, or the like of a periphery monitoring sensor used for the automatic driving. In the unplanned driving change, time since the driving change is requested to the driver until the automatic driving is cancelled has to be set shorter than that in a planned driving change. It is, therefore, difficulty that there is a driver who feels pressed as the driving change in short time is requested and cannot perform the driving change smoothly.

According to example embodiments, a travel support device enables a mode of driving change to be switched according to each of drivers at the time of driving change to unplanned manual driving in a vehicle performing automatic driving.

According to an example embodiment, a travel support device for a vehicle performing an automatic driving operation includes: a driving mode change unit that performs a driving mode change between the automatic driving operation and a manual driving operation; a vehicle stop unit that stops the vehicle; and a function selection unit that selects one of an on-request mode change function and an automatic stop function as an executing function, the on-request mode change function being for requesting a driver of the vehicle to perform the driving mode change, and performing the driving mode change using the driving mode change unit after continuing the automatic driving operation for a predetermined time interval when starting to perform the driving mode change which is unplanned, and the automatic stop function being for immediately starting to stop the vehicle using the vehicle stop unit without requesting the driver to perform the driving mode change.

According to the travel support device, the on-request change function of requesting driving change to the driver in the case of performing unplanned driving change, continuing the automatic driving for predetermined time and, after that, performing the driving change by the driving change unit or the automatic stop function of immediately starting stopping the vehicle by the stop unit without requesting the drive change to the driver can be selected. Therefore, by selecting the automatic stop function in the case of performing unplanned driving change, without requesting the driving change to a driver who feels pressed when the driving change in short time is demanded, stopping of the vehicle is immediately started by the vehicle stop unit and, after the vehicle is stopped, the driver can start the manual driving. As a result, in a vehicle performing automatic driving, at the time of driving change to unplanned manual driving, the mode of the driving change can be switched according to each driver.

With reference to the drawings, a plurality of embodiments for the disclosure will be described. For convenience of description, the same reference numerals are designated to parts having the same functions as those of parts illustrated in the drawings described in a plurality of embodiments, and their description may not be repeated. Regarding the parts to which the same reference numerals are designated, the description in another embodiment can be referred to.

### First Embodiment

Schematic Configuration of Travel Support System 1

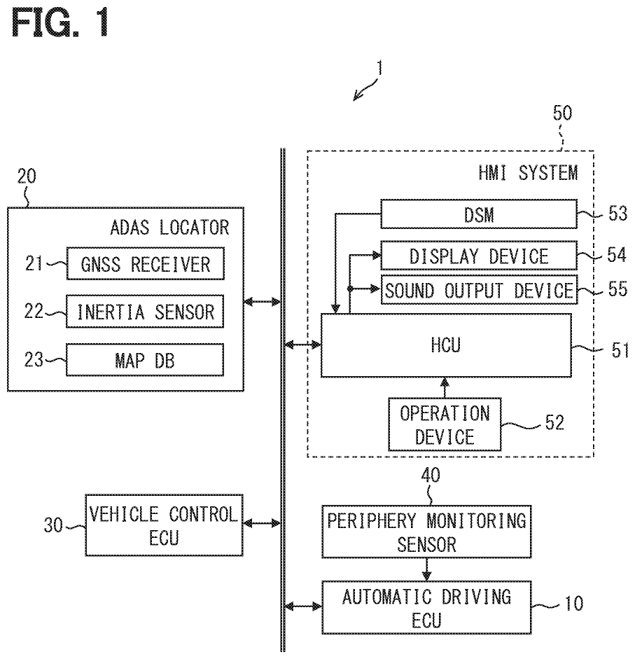

Hereinafter, a first embodiment of the present disclosure will be described with reference to the drawings. A travel support system 1 illustrated in FIG. 1 is used in a vehicle such as a car and includes an automatic driving ECU 10, an ADAS (Advanced Driver Assistance Systems) locator 20, a vehicle control ECU 30, a periphery monitoring sensor 40, and an HMI (Human Machine Interface) system 50. It is sufficient that the automatic driving ECU 10, the ADAS locator 20, the vehicle control ECU 30, and the HMI system 50 are connected to, for example, an in-vehicle LAN. In the following, a vehicle using the travel support system 1 will be called the present vehicle.

The ADAS locator 20 has a GNSS (Global Navigation Satellite System) receiver 21, an inertia sensor 22, and a map database (hereinbelow, DB) 23 storing map data. The GNSS receiver 21 receives positioning signals from a plurality of artificial satellites. The inertia sensor 22 has, for example, a triaxial gyroscope sensor and a triaxial acceleration sensor. The map DB 23 is a nonvolatile memory and stores map data such as link data, node data, road shapes, and structures. The map data may be a three-dimensional map made by a group of feature points of road shapes and structures.

The ADAS locator 20 sequentially measures the position of the present vehicle by combining a positioning signal received by the GNSS receiver 21 and a measurement result in the inertia sensor 22. For measurement of the position of a vehicle, travel distance obtained from pulse signals sequentially output from a wheel speed sensor of the present vehicle may be used. The measured vehicle position is output to an in-vehicle LAN. The ADAS locator 20 reads the map data from the map DB 23 and outputs it to the in-vehicle LAN. The map data may be obtained from the outside of the present vehicle by using a communication module. The ADAS locator 20 may have a configuration of sequentially specifying the position of the present vehicle to a three-dimensional map without having the GNSS receiver 21.

The vehicle control ECU 30 is an electronic control unit performing acceleration/deceleration control and steering control of the present vehicle. As the vehicle control ECU 30, there are a steering ECU performing steering control, a power unit control ECU and a brake ECU performing acceleration/deceleration control, and the like. The vehicle control ECU 30 obtains detection signals output from vehicle state sensors such as an accelerator position sensor, a brake pedal force sensor, a steering angle sensor, and a wheel speed sensor mounted in the present vehicle and outputs control signals to travel control devices such as an electronic control throttle, a brake actuator, and an EPS (Electric Power Steering) motor. The vehicle control ECU 30 can output the detection signals of the above-described vehicle state sensors to the in-vehicle LAN.

The periphery monitoring sensor 40 detects moving objects such as a pedestrian, an animal other than a human, a bicycle, a motorcycle, and another car and also obstacles such as a dropped thing on a road, a guardrail, a curb, and a tree. The periphery monitoring sensor 40 also detects road markings such as a pedestrian compartment line and a stop line. The periphery monitoring sensor 40 is, for example, a sensor of a periphery monitoring camera that captures images of a predetermined range in the periphery of the present vehicle, a millimeter-wave radar transmitting a search wave to a predetermined range in the periphery of the present vehicle, sonar, LIDAR (Light Detection and Ranging/Laser Imaging Detection and Ranging), and the like. The periphery monitoring camera sequentially outputs images which are sequentially captured as sensing information to the automatic driving ECU 10. The sensor transmitting a search wave such as the sonar, millimeter-wave radar, or LIDAR sequentially outputs a travel result based on a reception signal obtained in the case of receiving a reflection wave reflected by an obstacle as sensing information to the automatic driving ECU 10.

The HMI system 50 has, as illustrated in FIG. 1, an HCU (Human Machine Interface Control Unit) 51, an operation device 52, a DSM (Driver Status Monitor) 53, a display device 54, and a sound output device 55, receives an input operation from the driver of the present vehicle, monitors a driver condition of the driver of the present vehicle, and shows information to the driver of the present vehicle. The driver condition is either a physical condition or a psychological condition of the driver of the present vehicle. The physical condition is not limited to the body condition of the driver but may be a condition of inattentive driving of the driver.

The operation device 52 is a switch group operated by the driver of the present vehicle. The operation device 52 is used for making various settings. For example, as the operation device 52, there are a steering switch provided for the spoke part of the steering of the present vehicle, a touch switch integrated with the display device 54, and the like.

The DSM 53 is configured by, as an example, a near-infrared light source and a near-infrared camera and a control unit controlling them. The DSM 53 is disposed, for example, in a steering column cover in a posture that the near-infrared camera is directed toward the driver's seat side in the present vehicle. The DSM 53 may be disposed in another position as long as the face of the driver seated on the driver's seat in the present vehicle can be imaged and may be disposed in the top face of the instrument panel or the like.

The DSM 53 images the head of the driver irradiated with near-infrared light by the near-infrared light source by the near-infrared camera. The image captured by the near-infrared camera is analyzed by the control unit. The control unit detects, for example, the driver condition such as the orientation of the face of the driver, the direction of the eyes, sleepiness, and the like from the captured image. The detected driver condition is output to the HCU 51.

As an example, the DSM 53 detects parts such as the facial contour, eyes, nose, and mouth from an image captured by imaging the face of the driver by the near-infrared camera by image recognizing process. The orientation of the face of the driver is detected from relative position relations of the parts. The DSM 53 may detect the pupils and corneal reflex of the driver from the face image by the image recognizing process and detect the direction of the eyes relative to the reference position in the vehicle on the basis of the position relations of the detected pupils and corneal reflex. It is sufficient to set, as the reference position, for example, the mounting position of the near-infrared camera. The direction of the eyes may be detected also in consideration of the face orientation.

Further, the DSM 53 detects closing of the eyes by calculating a change of an eyelid shape detected from a face image as the eye-opening degree. From the temporal change of the eye-opening degree, the features of the shapes of the face parts, the temporal change of the face parts, and the like, the degree of sleepiness (hereinbelow, sleepiness level) is detected. As an example, the DSM 53 detects the sleepiness level which is sectioned into six stages of 1 to 6. The sleepiness sectioned in the six stages is expressed in descending order of wakefulness as the sleepiness level “1” at which the driver does not look like sleepy at all (in other words, in a wakeful state), the sleepiness level “2” at which the driver looks slightly sleepy, the sleepiness level “3” at which the driver looks sleepy, the sleepiness level “4” at which the driver looks very sleepy, the sleepiness level “5” at which the driver looks terribly sleepy, and the sleepiness level “6” at which the driver sleeps (in other words, sleeping state). The DSM 53 may detect the driver condition other than sleepiness such as concentration/discursion or pleasant/unpleasant from the features of the shapes of the face parts, the temporal change of the face parts, and the like detected from a face image.

The display device 54 displays various images for information notification and display information such as a text on the display screen on the basis of image data obtained from the HCU 51. Examples of the display device 54 include a display of a combination meter, a CID (Center Information Display), and an HUD (Head-Up Display). The display of the combination meter is disposed, for example, in front of the driver's seat. The CID is disposed above the center cluster. The HUD projects light of an image based on image data obtained from the HCU 51 to a projection region specified in a front window shield, thereby superimposing a virtual image of the image on a part of the front view, so that the driver can visually recognize an image. The projection member to which the HUD projects light is not limited to the front window shield but may be a translucent combiner.

An example of the sound output device 55 is an audio speaker. The audio speaker is disposed, for example, in the interior of a door in the present vehicle. The audio speaker presents information to the driver by sound which is reproduced.

The HCU 51 is configured by using a microcomputer as a main body, which has a processor, a non-transitory tangible storage medium such as a volatile memory or a nonvolatile memory, an I/O, and a bus connecting those components and is connected to the operation device 52, the DSM 53, the display device 54, the sound output device 55, and the in-vehicle LAN. The HCU 51 executes a control program stored in the nonvolatile memory, thereby executing various processes related to the functions of the HMI system 50.

The automatic driving ECU 10 is configured by using a microcomputer as a main body, which has a processor, a non-transitory tangible storage medium such as a volatile memory or a nonvolatile memory, an I/O, and a bus connecting those components and is connected to the periphery monitoring sensor 40 and the in-vehicle LAN. The automatic driving ECU 10 executes a control program stored in the nonvolatile memory by the processor, thereby executing various processes. Alternatively, a configuration of using a plurality of processors may be used. The automatic driving ECU 10 executes a function related to travel support such as an automatic driving function performing automatic driving of the present vehicle. The automatic driving ECU 10 corresponds to a travel support device.

Schematic Configuration of Automatic Driving ECU 10

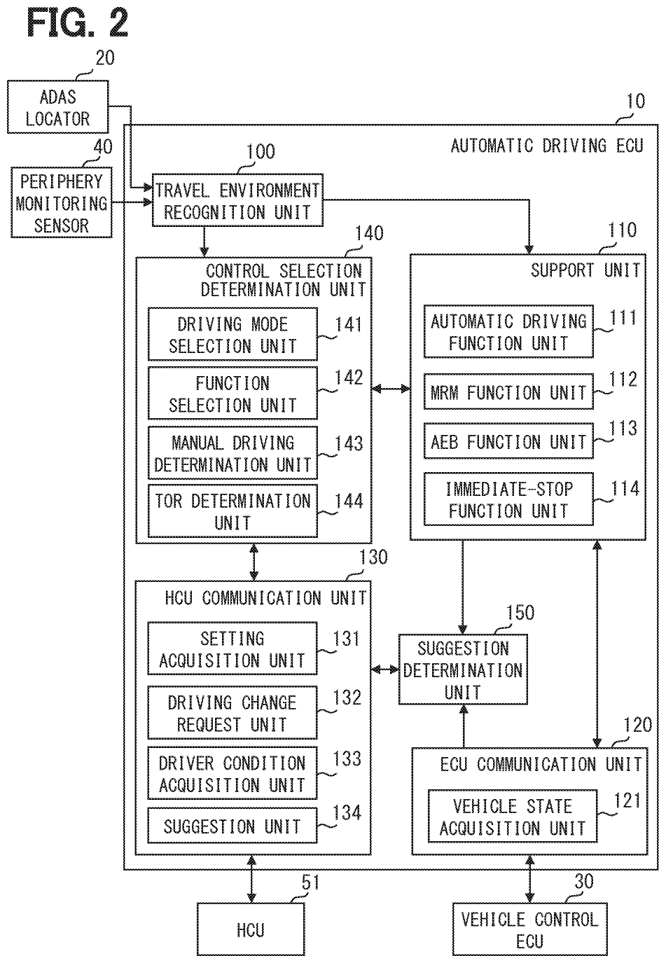

With reference to FIG. 2, the schematic configuration of the automatic driving ECU 10 will be described. As illustrated in FIG. 2, the automatic driving ECU 10 has, as function blocks, a travel environment recognition unit 100, a support unit 110, an ECU communication unit 120, an HCU communication unit 130, a control selection determination unit 140, and a suggestion determination unit 150. A part or all of the functions executed by the automatic driving ECU 10 may be configured by one or plural ICs or the like as hardware. A part or all of the function blocks of the automatic driving ECU 10 may be realized by a combination of execution of software by a processor and hardware members.

The travel environment recognition unit 100 recognizes travel environment of the present vehicle from the position of the present vehicle and map data obtained from the ADAS locator 20, sensing information obtained from the periphery monitoring sensor 40, and the like. As an example, the travel environment recognition unit 100 generates a virtual space obtained by three-dimensionally reproducing the actual travel environment by recognizing the shape and the moving state of an object around the present vehicle from the sensing information obtained from the periphery monitoring sensor 40 with respect to the sensing range of the periphery monitoring sensor 40 and combining them with the position of the present vehicle and the map data. In the travel environment recognition unit 100, it is sufficient to recognize, as travel environment, the distances to obstacles including a vehicle around the present vehicle, relative speeds of the obstacles to the present vehicle, and the like from the sensing information obtained from the periphery monitoring sensor 40. In the case where position information and speed information can be obtained from another car or a portable device carried by a passenger via a communication module, the travel environment may be recognized by also using the information.

The support unit 110 executes the function related to the travel support of the present vehicle. As illustrated in FIG. 2, the support unit 110 has, as sub function blocks executing the functions related to the travel support of the present vehicle, an automatic driving function unit 111, an MRM (Minimum Risk Maneuvers) function unit 112, an AEB (Autonomous Emergency Braking) function unit 113, and an immediate-stop function unit 114.

The automatic driving function unit 111 executes an automatic driving function performing automatic driving. In other words, the automatic driving function unit 111 automatically performs acceleration/deceleration control and steering control of the present vehicle in cooperation with the vehicle control ECU 30, thereby executing the driving operation of the present vehicle on behalf of the driver. On the basis of the travel environment recognized by the travel environment recognition unit 100, the automatic driving function unit 111 generates a travel plan for making the present vehicle travel by automatic driving.

For example, as a travel plan of the medium and long term, a recommended route for making the present vehicle travel toward a destination set by the driver or the like is generated. A schedule of a planned driving change from the automatic driving to the manual driving by the driver is set based on, mainly, a travel plan of the long and medium period. The automatic driving function unit 111 generates a short-period travel plan for performing travel according to the recommended route. As a concrete example, execution of steering for changing a lane, acceleration/deceleration for speed adjustment, steering and brake for avoiding an obstacle, and the like is determined. The automatic driving function unit 111 performs automatic driving by performing the acceleration/deceleration control and the steering control of the present vehicle in cooperation with the vehicle control ECU 30 in accordance with the generated travel plan. In the automatic driving function unit 111, as the automatic driving, it is assumed that automatic driving of automatically performing the acceleration/deceleration control and the steering control of the present vehicle is performed. The automatic driving performed by the automatic driving function unit 111 can be changed to manual driving.

In the case where, although a request to change the driving to manual driving is made during continuation of the automatic driving, there is no driving operation by the driver within setting time since the request is made, the MRM function unit 112 executes the MRM function of, for example, automatically evacuating the present vehicle. In the following description, it is assumed that the setting time is, for example, four seconds. Hereinafter, a request to change the driving to the manual driving, which is made from the travel support system 1 to the driver will be called a TOR (Take Over Request). As an example of the MRM function, by performing the acceleration/deceleration control and the steering control of the present vehicle in cooperation with the vehicle control ECU 30 on the basis of the travel environments recognized by the travel environment recognition unit 100, the present vehicle can be made automatically travel to a stoppable position and stop in a stop position.

When a TTC (Time To Collision) to an obstacle on a course of the present vehicle becomes below a setting value and an urgent control condition is satisfied, the AEB function unit 113 executes an AEB function of forcedly decelerating the present vehicle in cooperation with the vehicle control ECU 30. The setting value in this case may be an arbitrarily settable value which is, for example, less than three seconds.

The immediate stop function unit 114 executes an immediate stop function of automatically stopping the present vehicle without making the driving change request to the manual driving during continuation of the automatic driving. The immediate stop function corresponds to an automatic stop function. The immediate stop function unit 114 may have a configuration of automatically stopping the present vehicle by performing the deceleration control of the present vehicle in cooperation with the vehicle control ECU 30. Alternatively, the immediate stop function unit 114 may have a configuration of making the present vehicle evacuate to, for example, a road shoulder or the like by performing also the steering control of the present vehicle in cooperation with the vehicle control ECU 30. The immediate stop function unit 114 corresponds to a vehicle stop unit.

The immediate stop function unit 114 may also have a configuration of changing the deceleration at the time of automatically stopping the present vehicle in accordance with the relative speed or inter-vehicle distance to a vehicle behind the present vehicle. Concretely, it is preferable to decrease the deceleration as the relative speed becomes lower or decrease the deceleration as the inter-vehicle distance decreases. Alternatively, a configuration of changing the deceleration in accordance with the distance or TTC to an obstacle on the course of the present vehicle may be employed. Concretely, it is preferable to increase the deceleration as the distance to an obstacle on the course of the present vehicle decreases or increase the deceleration as the TTC decreases.

The ECU communication unit 120 performs a process of outputting information toward the vehicle control ECU 30 and a process of obtaining information from the vehicle control ECU 30. The ECU communication unit 120 generates vehicle control information of instructing acceleration/deceleration and steering in accordance with a function related to the travel support of the present vehicle executed by the support unit 110 and sequentially outputs it together with driving state information indicating the operation state of the automatic driving to the vehicle control ECU 30. The ECU communication unit 120 sequentially obtains state information indicating the control state of each travel control device from the vehicle control ECU 30 and can correct the vehicle control information.

The ECU communication unit 120 has a vehicle state acquisition unit 121 as a sub function block. The vehicle state acquisition unit 121 sequentially acquires signals output from the vehicle state sensors as vehicle state information. The vehicle state acquisition unit 121 may have a configuration of, for example, sequentially acquiring detection information indicative of a grip state of the steering wheel detected by a grip sensor provided for the steering wheel. The vehicle state information and the detection information is provided to a driving mode selection unit 141 which will be described later and used at the time of the drive change from the automatic driving to the manual driving.

The HCU communication unit 130 performs a process of outputting information to the HCU 51 and a process of obtaining information from the HCU 51. The HCU communication unit 130 has, as illustrated in FIG. 2, a setting acquisition unit 131, a driving change request unit 132, a driver condition acquisition unit 133, and a suggestion unit 134 as sub function blocks.

The setting acquisition unit 131 acquires setting information regarding a setting made by an operation input from the driver via the operation device 52, from the HCU 51. Examples of the setting information include a setting of whether the automatic driving function is executed or not and a setting of switching between an on-request change function and an immediate stop function which will be described later. Therefore, the operation device 52 corresponds to an operation input unit.

The driving change request unit 132 generates change request information of requesting a change from the automatic driving to the manual driving and outputs it to the HCU 51. The driving change request unit 132 makes a TOR of requesting the driver to change the driving to the manual driving by control of the display device 54 and/or the sound output device 55 in cooperation with the HCU 51.

The driver condition acquisition unit 133 acquires a driver condition of the driver of the present vehicle. The driver condition acquisition unit 133 may have a configuration of sequentially acquiring the driver condition detected by the DSM 53 from the HCU 51.

The suggestion unit 134 generates suggestion information of suggesting selection of a function to be executed from the on-request change function of continuing the automatic driving for predetermined time since the driving change is requested to the driver at the time of the automatic driving and changing the driving to the manual driving and the immediate stop function of automatically stopping the present vehicle without a driving change request, and outputs it to the HCU 51. In the case where the suggestion determination unit 150 which will be described later determines that it is a suggestion timing, the suggestion unit 134 suggests a function selection from the on-request change function and the immediate stop function to the driver by the control of the display device 54 and/or the sound output device 55 in cooperation with the HCU 51. Hereinafter, the suggestion will be called a selection suggestion. In the case of setting the on-request change function as a default, the selection suggestion as an example may be a suggestion to select the immediate stop function. It can be said that the selection suggestion corresponds to notification of notifying that the on-request change function and the immediate stop function can be selected. Therefore, the selection suggestion corresponds to selection notification, and the suggestion unit 134 corresponds to a notification instruction unit.

As an example, the selection suggestion may be performed by displaying a change-over switch as a touch switch for switching between the on-request change function and the immediate stop function to the display device 54. In this case, a configuration of performing display and/or sound output to announce switching between the on-request change function and the immediate stop function may be employed. Display information of the change-over switch which is displayed in the display device 54 corresponds to “display information”.

Alternatively, the selection suggestion may be performed by display and/or sound output indicating that the on-request change function and the immediate stop function can be switched. In this case, it is sufficient to select the on-request change function or the immediate stop function via a steering switch or the like. The selection suggestion may be performed by displaying a selection screen of selecting the on-request change function and the immediate stop function to the display device 54, and the on-request change function or the immediate stop function may be selected via a steering switch or the like.

The control selection determination unit 140 performs a process related to selection of a control according to a condition. The control selection determination unit 140 has, as illustrated in FIG. 2, the driving mode selection unit 141, a function selection unit 142, a manual driving determination unit 143, and a TOR determination unit 144 as sub function blocks.

The driving mode selection unit 141 switches the driving mode of the present vehicle among a plurality of predetermined modes by control of shifting the operation state of the function related to the travel support of the present vehicle. The driving mode selection unit 141 corresponds to a driving change unit. The plurality of driving modes switched by the driving mode selection unit 141 include, in addition to the manual driving mode of performing manual driving and the automatic driving mode of performing automatic driving, an urgent brake mode, an automatic evacuation mode, and an immediate stop mode.

In the manual driving mode, the automatic driving function is stopped, and the driver controls the travel of the present vehicle. The vehicle control ECU 30 which is obtaining the driving state information indicating the manual driving mode generates a control signal according to vehicle state information obtained from each of the vehicle state sensors and outputs the control signal to each of the travel control devices. In the automatic driving mode, the automatic driving function which is being executed controls travel of the present vehicle. The vehicle control ECU 30 which is obtaining the driving state information indicating the automatic driving mode generates a control signal according to vehicle control information obtained from the automatic driving function unit 111 and outputs the control signal to each of the travel control devices.

The urgent brake mode is a specific mode of the manual driving mode. In the urgent brake mode, when the above-described urgent control condition is satisfied at the time of manual driving, the AEB function is executed, and the present vehicle is forcedly decelerated in cooperation with the vehicle control ECU 30. The automatic evacuation mode is a specific mode of the automatic driving mode. In the automatic evacuation mode, although a request to change the driving to the manual driving is made during continuation of the automatic driving, in the case where the driving operation by the driver is not determined by the manual driving determination unit 143 within setting time since the request is made, the MRM function is executed and the present vehicle is, for example, automatically evacuated. The immediate stop mode is another mode of the automatic driving mode. In the immediate stop mode, at the time of an unplanned driving change from the automatic driving to the manual driving, the immediate stop function is executed and, without requesting the driving change, the present vehicle is stopped automatically.

It is sufficient to notify the driving mode selected by the driving mode selection unit 141 to the HCU 51, thereby displaying, for example, the driving mode which is being presently selected by the display device 54. By the configuration, the driver can easily recognize the driving mode which is presently selected.

As an example, the driving mode selection unit 141 switches selection between the manual driving mode and the automatic driving mode in accordance with setting of whether the automatic driving function is executed or not in the setting information acquired by the setting acquisition unit 131.

In the automatic driving mode, when an automatic driving section ends on the basis of the mid- and long-term travel plan generated by the automatic driving function unit 111, the driving mode selection unit 141 switches the automatic driving mode to the manual driving mode. In the following, it is called a planned driving change. In the planned driving change, it is sufficient to employ a configuration that a TOR is made during continuation of the automatic driving and, when the driving operation by the driver is determined by the manual driving determination unit 143 within setting time, the mode is switched to the manual driving mode. On the other hand, when the driving operation by the driver is not determined by the manual driving determination unit 143 within setting time, the mode is switched to the automatic evacuation mode. The setting time in this case is time which can be arbitrarily set as long as it does not exceed the automatic driving section in a state where the mode is not switched to the manual driving mode.

In addition, the driving mode selection unit 141 switches from the automatic driving mode to the manual driving mode when a situation that it is preferable to stop the automatic driving abruptly occurs in the automatic driving mode. Hereinafter, this will be called an unplanned driving change. An abruptly occurring situation in which it is preferable to stop the automatic driving is, for example, a case that decrease in sensing precision in the periphery monitoring sensor 40, abnormality of the periphery monitoring sensor 40, or the like is detected. Another case is that environment abnormality such as heavy rain or dense fog in which the sensing precision in the periphery monitoring sensor 40 cannot be assured is detected. Further another case is that a situation is detected in which, although a lane change is necessary to avoid an obstacle ahead, it is difficult to change to the adjacent lane. An unplanned driving change will be described specifically later.

The function selection unit 142 selects a function to be executed from the on-request change function and the immediate stop function in accordance with a setting of switching the on-request change function and the immediate stop function in the setting information acquired by the setting acquisition unit 131. As an example, when it is assumed that the on-request change function is selected as the default, in the case where a setting of switching to the immediate stop function is made by an operation input to the operation device 52, the immediate stop function is selected.

The manual driving determination unit 143 determines whether the driving operation by the driver is performed or not in relation to the driving change from the automatic driving to the manual driving. As an example, in the case where detection information indicating a grip state of the steering wheel obtained by the vehicle state acquisition unit 121 indicates that the steering wheel is gripped, it is determined that the driving operation by the driver is performed. Alternatively, it may be determined that the driving operation by the driver is performed on the basis of information other than the grip state of the steering wheel. When the manual driving determination unit 143 determines that the driving operation by the driver is performed at the time of the change from the automatic driving to the manual driving, the driving mode selection unit 141 switches from the automatic driving mode to the manual driving mode.

The TOR determination unit 144 determines whether a TOR is made or not at the time of the driving change from the automatic driving to the manual driving. When the on-request change function is selected from the on-request change function and the immediate stop function by the function selection unit 142 at the time of an unplanned driving change, the TOR determination unit 144 determines to make a TOR. In the case where the TOR determination unit 144 determines to make a TOR, an instruction is sent to the driving change request unit 132 to make a TOR. On the other hand, when the immediate stop function is selected from the on-request change function and the immediate stop function in the function selection unit 142 at the time of an unplanned driving change, the TOR determination unit 144 determines not to make a TOR.

At the time of an unplanned driving change, as an example, when the driving mode selection unit 141 determines to perform an unplanned driving change, the TOR determination unit 144 determines whether a TOR is made or not. Alternatively, the TOR determination unit 144 may determine whether a TOR is made or not when the automatic driving ECU 10 detects that a situation in which it is preferred to stop the automatic driving abruptly occurs.

It is sufficient for the TOR determination unit 144 to determine whether a TOR is made or not on the basis of a driving change schedule at the time of a planned driving change. As an example, it is sufficient to determine to make a TOR when a remaining distance or remaining travel time to a point where the driving is changed according to the driving change schedule becomes a predetermined value. The predetermined value in this case is a value which can be arbitrarily set.

The suggestion determination unit 150 determines a suggestion timing of performing a selection suggestion of suggesting a function selection from the on-request change function and the immediate stop function to the driver, sends an instruction to the suggestion unit 134, and makes the selection suggestion performed at the determined suggestion timing.

It is sufficient for the suggestion determination unit 150 to determine the suggestion timing when the setting of executing the automatic driving function is made by the operation input from the driver via the operation device 52. As an example, it is sufficient to determine, for example, a timing after predetermined time such as a few minutes since the setting of executing the automatic driving function is made as the suggestion timing. In this case, the selection suggestion is performed after the predetermined time since the setting of executing the automatic driving function is made. Alternatively, a suggestion timing may be determined in the case where a setting of performing the automatic driving function is made. In this case, the selection suggestion is performed immediately after the setting of executing the automatic driving function is made. It is sufficient to determine that the setting of executing the automatic driving function is made on the basis of the setting information of the setting acquisition unit 131. By the operation, the driver using the automatic driving function recognizes that the immediate stop function can be selected and it becomes easier to select the immediate stop function. Moreover, useless selection suggestion can be prevented from being made for a driver who does not use the immediate stop function as the driver does not use the automatic driving function.

The suggestion determination unit 150 may determine a suggestion timing when the travel of the present vehicle executing the automatic driving is finished. In this case, the selection suggestion is made at the timing when the travel of the present vehicle executing the automatic driving is finished. The end of the travel of the present vehicle may be stop of the present vehicle, parking of the present vehicle, or parking in the premise of the driver. It is sufficient to determine parking of the present vehicle on the basis of a pulse signal of a wheel speed sensor. It is sufficient to determine parking of the present vehicle on the basis of an operation of turning off a switch of starting a travel drive source, an operation of turning on a parking brake, setting of the shift position to the parking position, or the like. Whether the present vehicle is positioned in the premise of the driver or not may be determined from the position of the present vehicle and map data obtained from the ADAS locator 20. Execution of the automatic driving may be specified from the operation of the automatic driving function unit 111. By the operation, the driver using the automatic driving function recognizes that the immediate stop function can be selected in a relaxed state after the travel is finished and it becomes easier to select the immediate stop function. Moreover, useless selection suggestion can be prevented from being made for a driver who does not use the automatic driving function and also probably does not use the immediate stop function.

Further, the suggestion determination unit 150 may determine a determination timing on the basis of the fact that the driving is changed to the manual driving by the on-request change function of changing the driving to the manual driving after a TOR is made. As an example, it is sufficient to determine a timing after predetermined time such as a few minutes since the change to the manual driving is made by the on-request change function as the suggestion timing. In this case, the selection suggestion is performed after the predetermined time since the change to the manual driving is made by the on-request change function. Alternatively, a suggestion timing may be determined when the travel in which the driving is changed to the manual driving by the on-request change function is finished. In this case, the selection suggestion is performed at the timing when the travel in which the driving is changed to the manual driving by the on-request change function is finished. In a manner similar to the above description, the end of the travel of the present vehicle may be stop of the present vehicle, parking of the present vehicle, or parking in the premise of the driver. Consequently, the driver who receives a TOR recognizes that the immediate stop function can be selected in a relaxed state after time lapses since the TOR and it becomes easier to select the immediate stop function.

The suggestion determination unit 150 is not limited to the configuration of determining a suggestion timing on the basis of the fact that the driving is changed by the on-request change function at the time of an unplanned driving change but may have a configuration of determining a suggestion timing on the basis of the fact that the driving is changed by the on-request change function at the time of a planned driving change.

The suggestion determination unit 150 may also determine a suggestion timing on the basis of worsening in the driver condition obtained by the driver condition acquisition unit 133 in the automatic driving. As an example, it is sufficient to determine a suggestion timing in the case where the driver condition obtained by the driver condition acquisition unit 133 indicates worsening in the driver condition of a predetermined degree or more. In this case, a selection suggestion is made in the case where the driver condition obtained by the driver condition acquisition unit 133 indicates worsening in the driver condition of the predetermined degree or more. The predetermined degree in this case is a degree of worsening of the driver condition at a stage before a state in which the driving change becomes impossible such as a sleeping or unconscious state and may be a degree corresponding to a sign of sleepiness, poor physical condition, or the like.

By the above, at a timing when the possibility of requiring the immediate stop function increases due to worsening of the driver condition, the driver is made recognize that the immediate stop function can be selected and becomes easily select the immediate stop function. Therefore, even a driver who does not intend to use the immediate stop function in the beginning can easily switch from the on-request change function to the immediate stop function at a timing when the possibility of requiring the immediate stop function increases due to worsening of the driver condition. Moreover, useless selection suggestion can be prevented from being made for a driver whose condition is not worsened and whose possibility to require the immediate stop function is low.

Further, the suggestion determination unit 150 may determine the driving skill of the driver and determine a suggestion timing when the driving skill is equal to or less than a threshold. Therefore, the suggestion determination unit 150 corresponds to a skill determination unit. The threshold in this case can be arbitrarily set. The suggestion determination unit 150 may determine the driving skill of the driver and determine a suggestion timing when the driving skill is equal to or less than the threshold. In this case, the driving skill of the driver is determined and, when the driving skill is equal to or less than the threshold, the selection suggestion is performed. The suggestion timing may also be determined when the travel in which the driving skill is equal to or less than the threshold is finished. The end of the travel of the present vehicle may be, as described above, stop of the present vehicle, parking of the present vehicle, or parking in the premise of the driver. In this case, the driving skill of the driver is determined and, at the timing when the travel in the case where the driving skill is equal to or less than the threshold is finished, the selection suggestion is performed.

The driving skill of the driver may be determined from the behavior of the present vehicle to the travel environment recognized by the travel environment recognition unit 100 in the manual driving. The driving skill may be determined in two stages of “high” and “low” or three or more stages. As an example, when the percentage of changing a lane under a condition looser than the specification of the lane change in the automatic driving is high in the manual driving, the driving skill may be determined low. As a concrete example, it is sufficient to determine that the driving skill is low when the percentage that the driver cannot change a lane even the distance to a vehicle on the rear side is 20m or more although the driver shows the intension of changing the lane by the blinker or the like is high at the time of the manual driving versus the specification of changing a lane when the distance to a vehicle on the rear side is 20 m at the time of the automatic driving.

Consequently, a driver having low driving skill and having high possibility that the driver cannot calmly shift to the driving operation within setting time since a TOR is received, that is, a driver having high possibility of requiring the immediate stop function is made recognize that the immediate stop function can be selected and can easily select the immediate stop function. Moreover, useless selection suggestion can be prevented from being made for a driver who has a high driving skill and probably can calmly shift to the driving operation within the setting time since a TOR is received, that is, the driver having high possibility that the immediate stop function is unnecessary.

The suggestion timing determined by the suggestion determination unit 150 may be a part or all of the above-described timings. A suggestion timing other than the above-described timings may also be employed. The travel support system 1 is not limited to the configuration of switching between the on-request change function and the immediate stop function in accordance with an input via the operation device 52 from the driver who received a selection suggestion. For example, the on-request change function and the immediate stop function may be switched according to an input via the operation device 52 from a spontaneous driver who does not receive a selection suggestion, or the on-request change function and the immediate stop function may be switched by a setting in a dealer.

Driving Change Related Process in Automatic Driving ECU 10

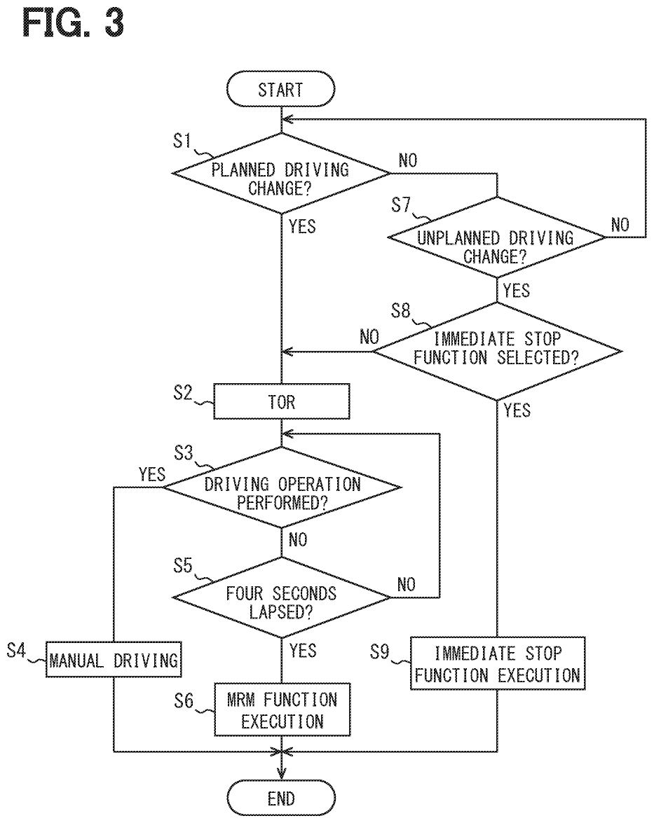

Subsequently, using the flowchart of FIG. 3, an example of the flow of a process related to the driving change from the automatic driving to the manual driving (hereinbelow, driving change related process) in the automatic driving ECU 10 will be described. For example, the flowchart of FIG. 3 may be started when the present vehicle starts the automatic driving.

First, in step 51, when the driving mode selection unit 141 performs the driving change to planned manual driving (YES in 51), the program shifts to step S2. On the other hand, when the driving change to planned manual driving is not performed (NO in 51), the process shifts to step S7. In step S2, the TOR determination unit 144 determines to perform a TOR on the basis of a driving change schedule. The driving change request unit 132 performs a TOR to the driver by the control of the display device 54 and/or the sound output device 55 in cooperation with the HCU 51.

In step S3, when the manual driving determination unit 143 determines that the driving operation of the driver is performed (YES in S3), the program shifts to step S4. On the other hand, when it is determined that the driving operation of the driver is not performed (NO in S3), the program shifts to step S5. In step S4, the driving mode selection unit 141 switches the automatic driving mode to the manual driving mode to start the manual driving by the driver and finishes the driving change related process.

In step S5, when four seconds of setting time has lapsed since a TOR is made (YES in S5), the program shifts to step S6. On the other hand, when four seconds has not lapsed since a TOR is made (YES in S5), the program returns to S3 and repeats the process. The lapse time since a TOR is made may be counted by, for example, a timer circuit in the automatic driving ECU 10 or the like. In step S6, the driving mode selection unit 141 switches the automatic driving mode to the automatic evacuation mode, the MRM function unit 112 executes the MRM function, and the driving change related process is finished.

In step S7, when the driving mode selection unit 141 performs an unplanned driving change to the manual driving (YES in S7), the program shifts to step S8. On the other hand, when the driving change to unplanned manual driving is not performed (NO in S7), the program returns to S1 and repeats the process. In step S8, when the function selection unit 142 selects the immediate stop function in accordance with the setting information obtained by the setting acquisition unit 131 (YES in S8), the program shifts to step S9. On the other hand, when the on-request change function is selected according to the setting information obtained by the setting acquisition unit 131 (NO in S8), the program shifts to S2. In step S9, the driving mode selection unit 141 switches from the automatic driving mode to the immediate stop mode, the immediate stop function unit 114 executes the immediate stop function to automatically stop the present vehicle without making a TOR, and the driving change related process is finished.

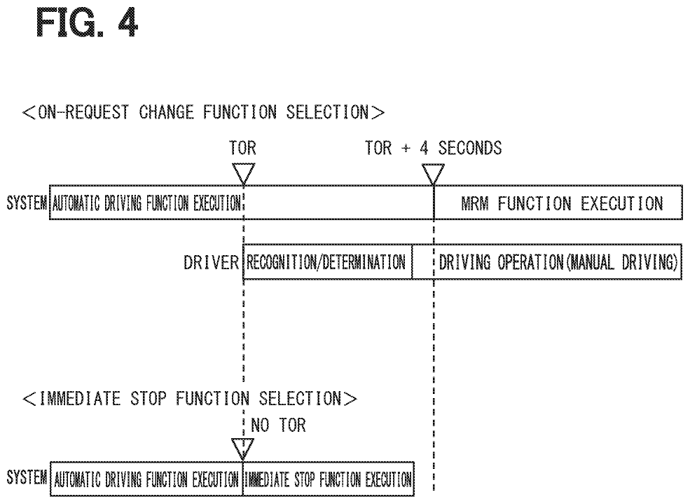

Referring to FIG. 4, the difference of the following vehicle control between the case where the on-request change function is selected by the function selection unit 142 and the case where the immediate stop function is selected will be described. In FIG. 4, the case where the driving change to unplanned manual driving is performed during continuation of the automatic driving will be described by using an example.

First, in the case where the on-request change function is selected by the function selection unit 142, by cooperation between the driving change request unit 132 and the HCU 51, a TOR is made to the driver. As illustrated in FIG. 4, the automatic driving function is executed until four seconds of the setting time lapses since the TOR is made, and the automatic driving is continued. The driver who recognizes reception of a TOR during continuation of the automatic driving has to straighten his/her posture during the four seconds as the setting time, determine the situation and, after that, start the driving operation.

When the driver can start the driving operation during four seconds since the TOR is made, the driving mode selection unit 141 switches from the automatic driving mode to the manual driving mode and, as illustrated in FIG. 4, the manual driving by the driver is started. On the other hand, when the driver cannot start the driving operation during four seconds since the TOR is made, as illustrated in FIG. 4, the MRM function unit 112 executes the MRM function and a proper procedure such as automatic evacuation can be taken on the travel support system 1 side.

Subsequently, when the immediate stop function is selected by the function selection unit 142, as illustrated in FIG. 4, at the timing when the TOR is made in the case of selecting the on-request change function is selected, the immediate stop function unit 114 executes the immediate stop function and starts deceleration for stopping the vehicle. That is, at the timing when a TOR is performed in the case of selecting the on-request change function, deceleration for stopping is started. When the intermediate stop function is selected by the function selection unit 142, as illustrated in FIG. 4, deceleration for stopping is started before four seconds as the setting time lapses.

As an advantage in the case of selecting the immediate stop function, since the deceleration for stopping can be started at a timing earlier than that in the case of selecting the on-request change function, the possibility of avoiding collision can be increased. For example, also in the case where the on-request change function is selected, deceleration can be performed by execution of the AEB function or MRM function after the manual driving change. In the case where the immediate stop function is selected, deceleration can be started at earlier timing, so that the possibility of collision avoidance can be increased.

### Summary of First Embodiment

According to the configuration of the first embodiment, in the case of performing unplanned driving change, the driver can select either the on-request change function of making a TOR to the driver and performing the driving change after continuing the automatic driving only for setting time or the immediate stop function of immediately starting stopping his/her vehicle without making a TOR to the driver. Consequently, the driver who feels pressed when the driving change is requested in short time can stop the present vehicle automatically and promptly without receiving a TOR by making a setting to select the immediate stop function. Therefore, the driver can shift to the manual driving in a relaxed manner after the his/her vehicle stops without feeling pressed by receiving a TOR. On the other hand, the driver who can shift to the manual driving in a relaxed manner even in the driving change in short time can shift to the manual driving without stopping his/her vehicle by making a setting of selecting the on-request change function. In such a manner, in a vehicle performing automatic driving, at the time of changing the driving to unplanned manual driving, the mode of the driving change can be switched according to each of drivers.

Since the immediate stop function can be selected other than the on-request change function, by selecting the immediate stop function, in a situation that the present vehicle has to be promptly stopped, the present vehicle can be stopped promptly without making a TOR and the situation can be dealt more promptly than the case where the on-request change function is selected.

### Second Embodiment

The first embodiment relates to the configuration that, in the case of performing the driving change to unplanned manual driving, the function selection unit 142 selects either the on-request change function or the immediate stop function in accordance with setting information which is preliminarily set in accordance with an operation input received by the operation device 52 from the driver. However, the present disclosure is not limited to the configuration. For example, a configuration of selecting either the on-request change function or the immediate stop function to be executed in accordance with a driver condition obtained by the driver condition acquisition unit 133 (hereinbelow, second embodiment) may be employed.

Hereinafter, the configuration of the second embodiment will be described. The travel support system 1 of the second embodiment is similar to the travel support system 1 of the first embodiment except for the point that an automatic driving ECU 10a is included in place of the automatic driving ECU 10. The automatic driving ECU 10a also corresponds to a travel support device.

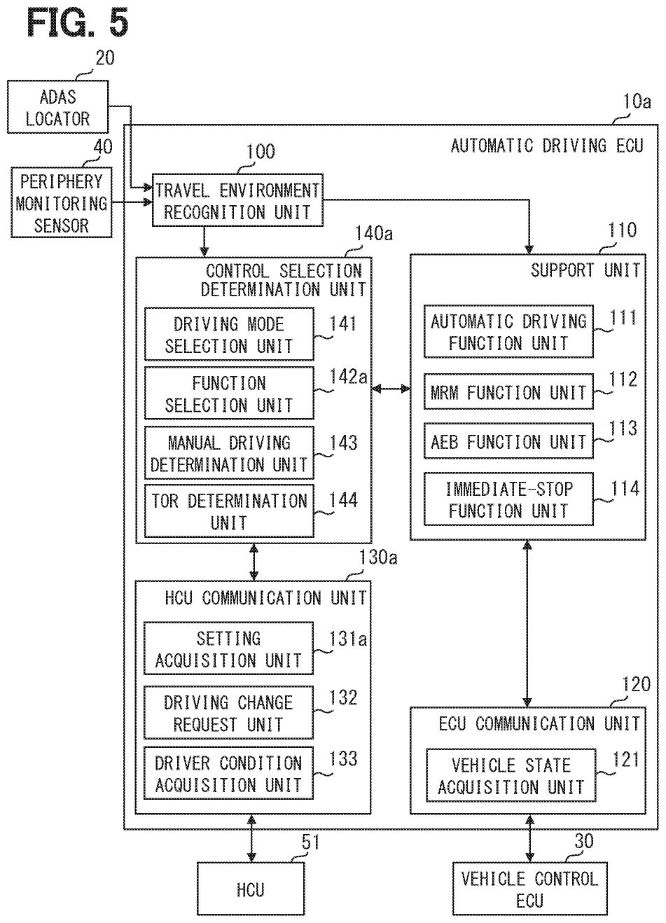

Referring to FIG. 5, a schematic configuration of the automatic driving ECU 10a in the second embodiment will be described. As illustrated in FIG. 5, the automatic driving ECU 10a has, as function blocks, the travel environment recognition unit 100, the support unit 110, the ECU communication unit 120, an HCU communication unit 130a, and a control selection determination unit 140a. The automatic driving ECU 10a is similar to the automatic driving ECU 10 of the first embodiment except for the point that the HCU communication unit 130a and the control selection determination unit 140a are provided in place of the HCU communication unit 130 and the control selection determination unit 140 and the point that the suggestion determination unit 150 is not provided.

As illustrated in FIG. 5, the HCU communication unit 130a has a setting acquisition unit 131a, the driving change request unit 132, and the driver condition acquisition unit 133 as sub function blocks. The HCU communication unit 130a is similar to the HCU communication unit 130 of the first embodiment except for the point that the setting acquisition unit 131a is provided in place of the setting acquisition unit 131 and the point that the suggestion unit 134 is not provided.

The setting acquisition unit 131a is similar to the setting acquisition unit 131 of the first embodiment except for the point that setting information regarding a setting of switching the on-request change function and the immediate stop function is not obtained. As an example, in the travel support system 1 of the second embodiment, it is assumed that the above-described changeover switch for switching between the on-request change function and the immediate stop function is not provided.

Subsequently, the control selection determination unit 140a has the driving mode selection unit 141, a function selection unit 142a, the manual driving determination unit 143, and the TOR determination unit 144 as sub function blocks. The control selection determination unit 140a is similar to the control selection determination unit 140 of the first embodiment except for the point that the function selection unit 142a is provided in place of the function selection unit 142.

The function selection unit 142a selects the on-request change function in the case where the driver condition obtained by the driver condition acquisition unit 133 is suitable for the manual driving and, on the other hand, selects the immediate stop function in the case where the driver condition is not suitable for the manual driving. The condition which is not suitable for the manual driving in this case may be the driver condition of the predetermined degree or higher described in the first embodiment or a condition under which the driving change to the manual driving is impossible such as a sleeping state, unconsciousness, or inattentive driving.

Preferably, in the case where the driving mode selection unit 141 changes to the unplanned manual driving, the function selection unit 142a more preferably uses the most recent driver conditions sequentially acquired by the driver condition acquisition unit 133 than using the driver condition newly acquired by the driver condition acquisition unit 133 in order to suppress delay in process.

The driving change related process in the automatic driving ECU 10a is similar to that in the automatic driving ECU 10 described in the first embodiment except for the point that the process in S8 is branched to selection of the immediate stop function and selection of the on-request change function in accordance with the driver condition acquired by the driver condition acquisition unit 133.

According to the configuration of the second embodiment, when the driver condition is a condition suitable for the manual driving, the on-request change function is selected to shift the driving to manual driving without stopping the present vehicle. On the other hand, when the driver condition is a condition which is not suitable for the manual driving, the immediate stop function is selected and the present vehicle can be stopped promptly without making a TOR. When the driver condition is a condition which is not suitable for the manual driving, by selecting the immediate stop function and promptly stopping the present vehicle without making a TOR, the situation in which the present vehicle has to be promptly stopped can be handled more promptly than the case of selecting the on-request change function.

### Third Embodiment

The second embodiment relates to the configuration that, in the case of performing the driving change to unplanned manual driving, the function selection unit 142a selects either the on-request change function or the immediate stop function without using setting information which is preliminarily set in accordance with an operation input received by the operation device 52 from the driver. However, the present disclosure is not limited to the configuration. For example, by combining the second and first embodiments, a configuration in which the setting information preliminarily set according to an operation input received by the operation device 52 from the driver can also be used for selection in the function selection unit 142a may be employed.

As an example, when the driver condition acquired by the driver condition acquisition unit 133 is a condition suitable for the manual driving described in the second embodiment, a configuration may be used that setting information which is preliminarily set according to an operation input received by the operation device 52 from the driver is used and, in a manner similar to the first embodiment, the function selection unit 142a selects either the on-request change function or the immediate stop function. On the other hand, when the driver condition acquired by the driver condition acquisition unit 133 is a condition which is not suitable for the manual driving described in the second embodiment, a configuration that, regardless of the setting information preliminarily set according to the operation input received by the operation device 52 from the driver, the function selection unit 142a selects the immediate stop function in a manner similar to the second embodiment may be used.

### Fourth Embodiment

The foregoing embodiments relate to the configuration that, as the on-request change function, even in the case where a TOR is made and, after that, the driver does not perform the driving operation, the automatic driving ECU 10 (that is, the system side) executes the MRM function. Specifically, the configuration of the case of applying the present disclosure to a vehicle performing the automatic driving corresponding to the level 4 of the automation level of the automatic driving defined by the SAE International is employed. However, the present disclosure is not always limited to the configuration. For example, a configuration of applying the present disclosure to a vehicle performing automatic driving corresponding to the levels 2 and 3 of the automation level may be employed.

The levels 2 to 4 of the automation level of the automatic driving defined by the SAE International will be described. The level 2 is partial automation which is automatic driving that the system performs steering and acceleration/deceleration according to travel environments and the driver performs the driving operation of the part which is not assisted by the system.

The level 3 is conditional automation and automatic driving that, under condition that the driver properly responds to a driving change request from the system, the automated system performs the driving operation of the vehicle in a specific driving mode. In other words, at the level 3, at the time of driving change to the manual driving, a TOR is made, the system side continues the automatic driving for predetermined time, and the automatic driving is finished.

The level 4 is high automation and automatic driving that, even the driver does not properly respond to a driving change request from the system, the automated system performs the driving operation of the vehicle in a specific driving mode. In other words, at the level 4, at the time of driving change to the manual driving, a TOR is made, the system side continues the automatic driving for predetermined time and, even in the case where the driving does not shift to the manual driving, the system side performs a procedure such as automatic evacuation.

For example, in the case of applying the present disclosure to a vehicle performing automatic driving corresponding to the level 2 in the automation level, it is sufficient to employ a configuration that the automatic driving function unit 111 makes the automatic driving corresponding to the level 2 performed. In the case of applying the present disclosure to a vehicle performing automatic driving corresponding to the level 3 in the automation level, it is sufficient to employ a configuration that the automatic driving function unit 111 makes the automatic driving corresponding to the level 3 performed.

In the case of applying the present disclosure to a vehicle performing automatic driving corresponding to the levels 2 and 3 in the automation level, it is sufficient to employ the following configuration. As an example, a configuration may be employed that when the on-request change function is selected at the time of driving change to the unplanned manual driving, after the setting time lapses since a TOR is made, the driving mode selection unit 141 switches from the automatic driving mode to the manual driving mode. On the other hand, a configuration may be employed that when the immediate stop function is selected at the time of driving change to the unplanned manual driving, the driving mode selection unit 141 switches from the automatic driving mode to the immediate stop mode. Also in the case of applying the present disclosure to a vehicle performing the automatic driving corresponding to the levels 2 and 3 in the automation level, by promptly stopping the present vehicle when the immediate stop function is selected, the driver can shift to the manual driving in relaxed manner, and the possibility of collision avoidance can be increased.

### Fifth Embodiment

The foregoing embodiments relate to the configuration of using the DSM 53 for detection of the driver condition. However, the present disclosure is not always limited to the configuration. For detection of the driver condition, a configuration of using a vehicle signal such as temporal change or the like of a steering angle detected by a steering sensor of the present vehicle may be employed, or a configuration using a biological sensor such as a pulse wave sensor, a cardiac sensor, or a respiration sensor may employed. Accompanying it, a configuration of targeting at a driver condition other than the driver condition which can be detected by using the DSM 53 may also be employed.

The biological sensor may be provided in the present vehicle, for example, in the steering wheel, the driver's seat, or the like, or may be provided in a wearable device which is worn by the driver. In the case where a biological sensor is provided for a wearable device worn by the driver, for example, the HCU 51 may obtain a result of detection in the biological sensor.

### Sixth Embodiment

The foregoing embodiments relate to the configuration of selecting the on-request change function without selecting the immediate stop function from the on-request change function and the immediate stop function in the case of changing the driving to planned manual driving. However, the present disclosure is not always limited to the configuration. For example, also in the case of changing the driving to planned manual driving, in a manner similar to the case of changing the driving to unplanned manual driving, the function selection unit 142 or 142a may select either the on-request change function and the immediate stop function. That is, regardless of the planned driving change or unplanned driving change, either the on-request change function or the immediate stop function may be selected.

With the configuration, even at the time of changing the driving to planned manual driving, by making a setting of selecting the immediate stop function, the driver who feels pressed when he/she receives a TOR can automatically and promptly stop his/her vehicle without receiving a TOR. Therefore, even at the time of changing the driving to planned manual driving, the driver does not feel pressed by receiving a TOR. After his/her vehicle stops, the driver can move to the manual driving in a relaxed manner.

### Seventh Embodiment

Although the configuration that the automatic driving ECU 10 or 10a is made by a single ECU has been described in the foregoing embodiments, the present disclosure is not always limited to the configuration. Although the configuration that the automatic driving ECUs 10 and 10a, the HCU 51, and the vehicle control ECU 30 are different from one another has been described, the present disclosure is not always limited to the configuration. For example, the automatic driving ECU 10 or 10a may be a part or all of the functions of the HCU 51 or a part or all of the functions of the vehicle control ECU 30.

Here, the process of the flowchart or the flowchart described in this application includes a plurality of sections (or steps), and each section is expressed as, for example, S1. Further, each section may be divided into several subsections, while several sections may be combined into one section.

Furthermore, each section thus configured may be referred to as a device, module, or means.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. A travel support device for a vehicle performing an automatic driving operation comprising:
a driving mode change unit that performs a driving mode change between the automatic driving operation and a manual driving operation;
a vehicle stop unit that stops the vehicle; and
a function selection unit that selects one of an on-request mode change function and an automatic stop function as an executing function,
the on-request mode change function being for requesting a driver of the vehicle to perform the driving mode change, and performing the driving mode change using the driving mode change unit after continuing the automatic driving operation for a predetermined time interval when starting to perform the driving mode change which is unplanned, and
the automatic stop function being for immediately starting to stop the vehicle using the vehicle stop unit without requesting the driver to perform the driving mode change, wherein:
when starting to perform the driving mode change which is unplanned, the function selection unit selects the one of the on-request mode change function and the automatic stop function according to setting information preliminarily set based on an operation of selecting the one of the on-request mode change function and the automatic stop function received from the driver by an operation input unit which receives an operation from the driver; and
the setting information indicates whether to perform the on-request mode change function or the automatic stop function.

2. The travel support device according to claim 1, wherein:
the automatic stop function begins to stop the vehicle by starting to decelerate the vehicle using the vehicle stop unit when requesting the driver to perform the driving mode change in a case where the function selection unit selects the on-request mode change function.

3. The travel support device according to claim 1, further comprising:
a driver condition acquisition unit that acquires a driver condition of at least one of a physical condition or a psychological condition of the driver, wherein:
when starting to perform the driving mode change which is unplanned, the function selection unit selects the on-request mode change function when the driver condition acquired by the driver condition acquisition unit is suitable for the manual driving operation in a case where the operation of selecting the on-request mode change function is received by the operation input unit from the driver; and
when starting to perform the driving mode change which is unplanned, the function selection unit selects the automatic stop function when the driver condition acquired by the driver condition acquisition unit is not suitable for the manual driving operation in a case where the operation of selecting the on-request mode change function is received by the operation input unit from the driver.

4. The travel support device according to claim 1, further comprising:
a notification instruction unit that performs selection notification indicating that selection between the on-request mode change function and the automatic stop function is executable.

5. The travel support device according to claim 4, wherein:
the selection notification performed by the notification instruction unit is display information for suggesting the driver to perform the operation of selecting one of the on-request mode change function or the automatic stop function using the operation input unit, the display information being displayed on a screen of a display device in the vehicle.

6. The travel support device according to claim 4, wherein:
the notification instruction unit performs the selection notification after a predetermined time interval elapses since the driving mode change is performed by the on-request mode change function.

7. The travel support device according to claim 4, further comprising:
a skill determination unit that determines a driving skill of the driver, wherein:
the notification instruction unit performs the selection notification based on a feature that the driving skill of the driver determined by the skill determination unit is equal to or less than a threshold.

8. The travel support device according to claim 4, wherein:
in the vehicle, it is settable whether an automatic driving function of performing the automatic driving operation is to be used; and
the notification instruction unit performs the selection notification when it is set that the automatic driving function of performing the automatic driving operation is to be used.

9. The travel support device according to claim 4, wherein:
when a travel of the vehicle executing the automatic driving operation is finished, the selection notification is performed.

10. The travel support device according to claim 4, further comprising:
a driver condition acquisition unit that acquires a driver condition of at least one of a physical condition or a psychological condition of the driver, wherein:
the notification instruction unit performs the selection notification based on a feature that the driver condition acquired by the driver condition acquisition unit worsens when performing the automatic driving operation.

11. The travel support device according to claim 1, further comprising:
a driver condition acquisition unit that acquires a driver condition of at least one of a physical condition or a psychological condition of the driver, wherein:
when starting to perform the driving mode change which is unplanned, the function selection unit selects the on-request mode change function when the driver condition acquired by the driver condition acquisition unit is suitable for the manual driving operation; and
when starting to perform the driving mode change which is unplanned, the function selection unit selects the automatic stop function when the driver condition acquired by the driver condition acquisition unit is not suitable for the manual driving operation.

12. The travel support device according to claim 1, wherein:
when starting to perform the driving mode change which is unplanned, the on-request mode change function is executed, and the automatic stop function is not executed.

13. A travel support device for a vehicle performing an automatic driving operation comprising:
a processor with a memory, wherein:
the processor is configured to:
perform a driving mode change between the automatic driving operation and a manual driving operation;
stop the vehicle; and
select one of an on-request mode change function and an automatic stop function as an executing function;
the on-request mode change function is for requesting a driver of the vehicle to perform the driving mode change, and for performing the driving mode change using the driving mode change unit after continuing the automatic driving operation for a predetermined time interval when starting to perform the driving mode change which is unplanned;
the automatic stop function is for immediately starting to stop the vehicle using the vehicle stop unit without requesting the driver to perform the driving mode change;
when starting to perform the driving mode change which is unplanned, the processor is configured to select the one of the on-request mode change function and the automatic stop function according to setting information preliminarily set based on an operation of selecting the one of the on-request mode change function and the automatic stop function received from the driver by an operation input unit which receives an operation from the driver; and
the setting information indicates whether to perform the on-request mode change function or the automatic stop function.
